(19) United States
(12) Patent Application Publication
(10) Pub. No.: US 2026/0222429 A1
(43) Pub. Date: Jul. 30, 2026

(54) DNS TRAFFIC PROFILING AND MALICIOUS DNS RESOLUTION PATTERN DETECTION

(71) Applicant: Palo Alto Networks, Inc., Santa Clara, CA (US)

(72) Inventors: Zhanhao Chen, Sunnyvale, CA (US); Reethika Ramesh, Sunnyvale, CA (US); Daiping Liu, Sunnyvale, CA (US)

(21) Appl. No.: 19/037,852

(22) Filed: Jan. 27, 2025

(51) Int. Cl. H04L 9/40

(52) U.S. Cl. CPC H04L 63/1425; H04L 63/1416

(57) ABSTRACT

The present application discloses a method, system, and computer system for detecting malicious DNS traffic. The method includes (i) performing an autoencoder-based DNS traffic profiling to obtain a DNS traffic profile, (ii) obtaining a classification for DNS traffic associated with the time series DNS traffic data based at least in part on the DNS traffic profile, and (iii) performing an action based at least in part on the classification. The autoencoder-based DNS traffic profiling is based at least in part on time series DNS traffic data. The classification is obtained based at least in part on querying a classifier for a predicted classification.

### BACKGROUND OF THE INVENTION

The Domain Name System (DNS) is a foundational component of the internet, translating human-readable domain names into machine-readable IP addresses to facilitate communication between devices. Despite its critical role, DNS has increasingly become a target and vehicle for cyberattacks. Malicious actors exploit DNS infrastructure to carry out activities such as data exfiltration, command-and-control (C2) communications, and domain generation algorithm (DGA)-based attacks. As these threats grow more sophisticated, traditional approaches to DNS traffic monitoring and threat detection face limitations in their ability to identify malicious patterns effectively, particularly in real-time environments.

### BRIEF DESCRIPTION OF THE DRAWINGS

Various embodiments of the invention are disclosed in the following detailed description and the accompanying drawings.

FIG. 1 is a block diagram of an environment for providing a security service to a network according to various embodiments.

FIG. 2 is a block diagram of a system to perform DNS traffic classifications according to various embodiments.

FIG. 3 is a block diagram of a system to perform DNS traffic classifications according to various embodiments.

FIG. 4 is an illustration of examples of time series data for various DNS traffic types.

FIG. 5A is an illustration of an example of time series data for DNS traffic associated with a phishing attack.

FIG. 5B is an illustration of an example of time series data for DNS traffic associated with a spam email attack.

FIG. 5C is an illustration of an example of time series data for DNS traffic associated with a squatting domain attack.

FIGS. 6A and 6B are illustrations of representative examples of time series data for DNS traffic.

FIG. 7 is a flow diagram of a method for detecting malicious DNS traffic based at least in part on a DNS traffic profile according to various embodiments.

FIG. 8 is a flow diagram of a method for detecting malicious DNS traffic based at least in part on a DNS traffic profile according to various embodiments.

FIG. 9 is a flow diagram of a method for obtaining a DNS traffic profile based at least in part on intercepted DNS traffic according to various embodiments.

FIG. 10 is a flow diagram of a method for obtaining pre-processed DNS traffic based at least in part on intercepted DNS traffic according to various embodiments.

FIG. 11 is a flow diagram of a method for obtaining pre-processed DNS traffic based at least in part on intercepted DNS traffic according to various embodiments.

FIG. 12 is a flow diagram of a method for training a classifier for performing DNS traffic classifications according to various embodiments.

FIG. 13 is a flow diagram of a method for handling DNS traffic based on a predicted DNS traffic classification.

FIG. 14 is a flow diagram of a method for obtaining a DNS traffic profile based at least in part on intercepted DNS traffic according to various embodiments.

FIG. 15 is a flow diagram of a method for handling DNS traffic based on DNS traffic classifications according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

As used herein, a model includes a machine learning model and/or a deep learning model. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc.

As used herein, a DNS traffic profile may be a fixed-dimensional representation of DNS traffic data. The DNS traffic profile may be based on the DNS traffic data and time data for the DNS traffic data, such as time series DNS traffic data. In some embodiments, the DNS traffic profile is generated by encoding the original, variable-length time series data associated with the DNS traffic. According to various embodiments, this DNS traffic profile encapsulates both the content of the DNS traffic (e.g., queries, responses, domain names, and associated metadata) and its temporal characteristics (e.g., the timing and frequency of DNS events).

DNS resolution traffic, as the initial stage of network communication, provides critical insights into potential attack indicators associated with malicious hostnames. A key aspect is the analysis of DNS traffic trend characteristics, which can signal unauthorized penetration attempts. For example, upon infiltrating a victim's device, a trojan typically activates periodically to establish connection to its Command and Control (C&C) hostnames, resulting in stable and periodic DNS requests patterns for these domains. However, the raw traffic data comparison is computationally expensive, and the time series will keep growing. Therefore, storing and processing the traffic trend data efficiently and at scale is challenging.

Current systems often rely on static rule-based mechanisms or manual inspection of DNS traffic logs to detect malicious activity. These methods are time-consuming and prone to inaccuracies, as they struggle to adapt to the dynamic and evolving nature of DNS traffic. While some solutions incorporate machine learning models for classification, they fail to account for the temporal characteristics of DNS traffic, which are crucial for distinguishing between benign and malicious patterns. Additionally, these models frequently require extensive computational resources and are ill-suited for real-time deployment within security entities such as firewalls or intrusion detection systems.

Various embodiments address these challenges by introducing a system that leverages time series analysis and advanced machine learning techniques to detect and classify DNS traffic more effectively. By encoding time information with DNS traffic data, the system captures temporal patterns and behaviors indicative of malicious activity. The use of a deep learning-based RNN autoencoder enables the transformation of variable time series data into fixed-dimensional vectors, or DNS traffic profiles, which preserve essential characteristics of the original data. These profiles are then used as inputs for a high-precision classification model to identify malicious traffic with improved accuracy.

Various embodiments provide a system, method, and/or device for detecting and classifying Domain Name System (DNS) traffic, particularly focusing on the detection of malicious patterns within DNS traffic. The system analyzes DNS traffic intercepted by a security entity, such as a firewall, and classifies the DNS traffic (or the corresponding domain) either through an external server queried by the security entity or directly in-line with the security entity's operations. This in-line classification can be contemporaneous or near real-time with the handling of the intercepted DNS traffic.

In some embodiments, the system determines a DNS traffic profile based on the DNS traffic. For example, the system determines the DNS traffic profile based on a DNS traffic time series data (e.g., a set of DNS traffic samples over time). In some embodiments, the DNS traffic profile is generated through a deep learning-based process, such as a recurrent neural network (RNN) autoencoder. The autoencoder obtains the original DNS traffic time series data as input, processes it to encode critical features, and outputs a compressed intermediate representation. This representation retains the essential patterns and behaviors of the original traffic, including temporal dependencies, while reducing its dimensionality. As an example, the DNS traffic profile is designed to be a concise yet comprehensive summary of the DNS traffic, optimized for use in downstream classification tasks.

In some embodiments, the DNS traffic profile serves as the input for a classification model, such as a random forest classifier, which uses the DNS traffic profile to determine a predicted classification (e.g., a DNS traffic classification, a maliciousness classification, etc.). For example, the system uses the DNS traffic profile to classify the DNS traffic differentiate between benign and malicious DNS activity. By transforming raw traffic data into these structured DNS traffic profiles, the system simplifies the computational process and enhances the accuracy of detecting threats within DNS traffic.

The system identifies DNS traffic using time series data associated with the traffic. By incorporating the temporal characteristics of DNS traffic, the system enables more accurate detection of patterns indicative of malicious activity. For example, the system identifies malicious DNS traffic based on patterns observed in the time series component of the DNS traffic data. To achieve this, the system encodes both the DNS traffic data and associated time information to generate a corresponding DNS traffic profile. As an example, the DNS traffic profile can capture essential characteristics of the time series data, making it suitable for subsequent classification.

In some embodiments, the system implements a recurrent neural network (RNN)-based autoencoder to process the time series DNS traffic data. As an example, the autoencoder is a deep learning model comprising RNN cells and is trained to encode and decode the DNS traffic time series data, thereby transforming variable time series inputs into fixed-dimensional representations. During the training process, the autoencoder uses the same time series data as both input and ground truth. The encoder compresses the data into an intermediate representation, and the decoder reconstructs (or attempts to) the original DNS traffic data from this intermediate form. The reconstruction loss, calculated by comparing the original input with the decoded output can be used to optimize the model. According to various embodiments, the intermediate representation, or output of the encoder (and input to the decoder), is deemed as the DNS traffic profile.

According to various embodiments, the system utilizes these DNS traffic profiles to classify the traffic. A high-precision classification model, such as a random forest classifier, is trained to differentiate between benign and malicious DNS traffic. The classifier relies on the encoded traffic profiles, which encapsulate both the DNS data and its temporal attributes, to identify patterns indicative of malicious domains or activities. This classification enables the system to detect threats with greater accuracy and speed.

To integrate temporal characteristics into the encoding process, the system calculates time intervals between data points in the DNS traffic. These time intervals are derived from timestamp data included in, or associated with, the DNS traffic. In some embodiments, the system computes the logarithm of the time intervals to normalize the data and uses the logarithmic values as the time data for encoding. By incorporating this processed time data into the encoding stage, the system can capture critical temporal features of the DNS traffic.

The system can be implemented for real-time detection and can be seamlessly integrated into the log delivery pipeline of a security entity. This integration allows the system to continuously update DNS traffic profiles as new traffic data is received. By dynamically adapting to changing traffic patterns, the system ensures robust detection and classification of both known and emerging threats.

In some embodiment, the system optimizes computational efficiency by reducing the dimensionality of the input data while preserving critical characteristics. This is achieved through the transformation of variable-length time series data into lower-dimensional fixed vectors during the encoding process. These fixed-dimensional representations, or DNS traffic profiles, are computationally efficient and enable the real-time operation of the classification model.

Various embodiments provide a method, system, and computer system for detecting malicious DNS traffic. The method includes (i) performing an autoencoder-based DNS traffic profiling to obtain a DNS traffic profile, (ii) obtaining a classification for DNS traffic associated with the time series DNS traffic data based at least in part on the DNS traffic profile, and (iii) performing an action based at least in part on the classification. The autoencoder-based DNS traffic profiling is based at least in part on time series DNS traffic data. The classification is obtained based at least in part on querying a classifier for a predicted classification.

Various embodiments are particularly suited for integration into real-time security pipelines, enabling continuous updates to DNS traffic profiles as new data is processed. By reducing the dimensionality of dynamic time series data while preserving critical information, the system significantly enhances computational efficiency without compromising detection precision. The system can protect DNS infrastructure against emerging threats and addressing the limitations of existing detection technologies.

According to various embodiments, the system for detecting malicious DNS traffic is implemented by one or more servers. The one or more servers may provide a service for one or more customers and/or security entities. For example, the one or more servers detect malicious DNS traffic, and provide an indication of whether DNS traffic is malicious to the one or more customers and/or security entities. The one or more servers provide to a security entity the indication that a file is malicious in response to a determination that the DNS traffic is malicious and/or in connection with an updated to a mapping of DNS traffic to indications of whether the files of malicious (e.g., an update to a blacklist comprising identifier(s) associated with a malicious file(s)). As another example, the one or more servers determine whether DNS traffic is malicious in response to a request from a customer or security for an assessment of whether DNS traffic is malicious, and the one or more servers provide a result of such a determination.

According to various embodiments, the system for detecting malicious DNS traffic is implemented by a security entity. For example, the system for detecting malicious DNS traffic is implemented by a firewall. As another example, the system for detecting the malicious DNS traffic is implemented by an application such as anti-malware application running on a device (e.g., a computer, laptop, mobile phone, etc.). According to various embodiments, the security entity receives DNS traffic (e.g., a set of DNS traffic samples), obtains time series data for the DNS traffic, and determines whether the DNS traffic is malicious based at least in part on time series data. In response to determining that the DNS traffic is malicious, the security entity applies one or more security policies with respect to the DNS traffic. In response to determining that the DNS traffic is not malicious (e.g., that the DNS traffic is benign), the security entity handles the DNS traffic as non-malicious traffic.

According to various embodiments, a security entity and/or network node (e.g., a client, device, etc.) handles DNS traffic based at least in part on an indication that the DNS traffic is malicious and/or that the DNS traffic matches a DNS traffic (or corresponds to a domain) indicated to be malicious. In response to receiving indication that the DNS traffic (e.g., the DNS traffic sample is malicious), the security network and/or network node may update a mapping of DNS traffic (or domains, or other hash of the DNS record, etc.) to an indication of whether the corresponding DNS traffic is malicious, and/or a blacklist of DNS traffic (e.g., a blacklist/denylist for DNS records or domains). In some embodiments, the security entity and/or the network node receives a signature pertaining to DNS traffic (e.g., a sample, such as a domain or DNS record, deemed to be malicious), and the security entity and/or the network node stores the signature of the DNS traffic (e.g., a hash for the domain, the DNS records, or other DNS data, etc.) for use in connection with detecting whether DNS traffic obtained, such as via network traffic, are malicious (e.g., based at least in part on comparing a signature generated for the DNS traffic with a signature for DNS traffic samples comprised in a blacklist/denylist of DNS traffic, such as domains or DNS records, or signatures thereof). As an example, the signature may be a hash.

Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security entities (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a DNS record, a DNS response, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

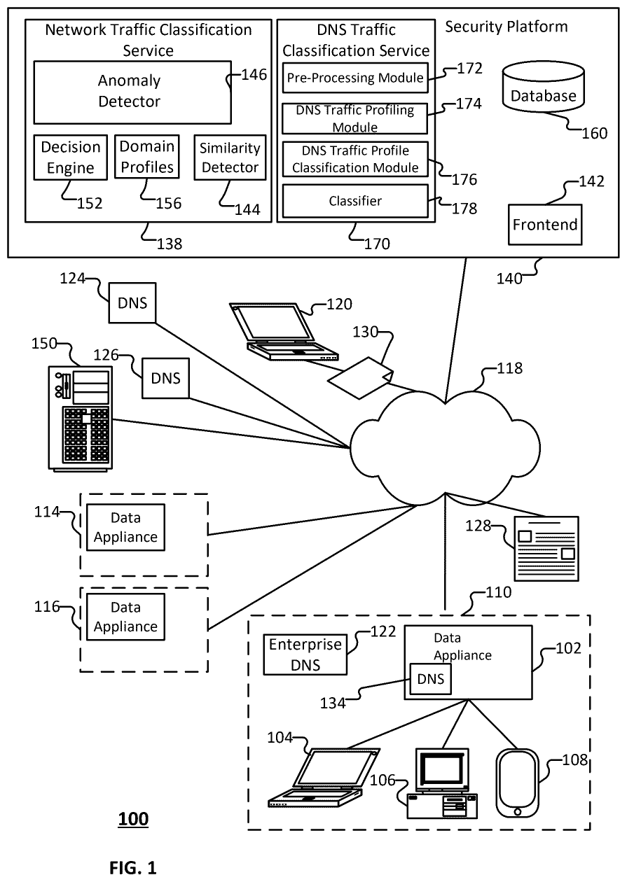

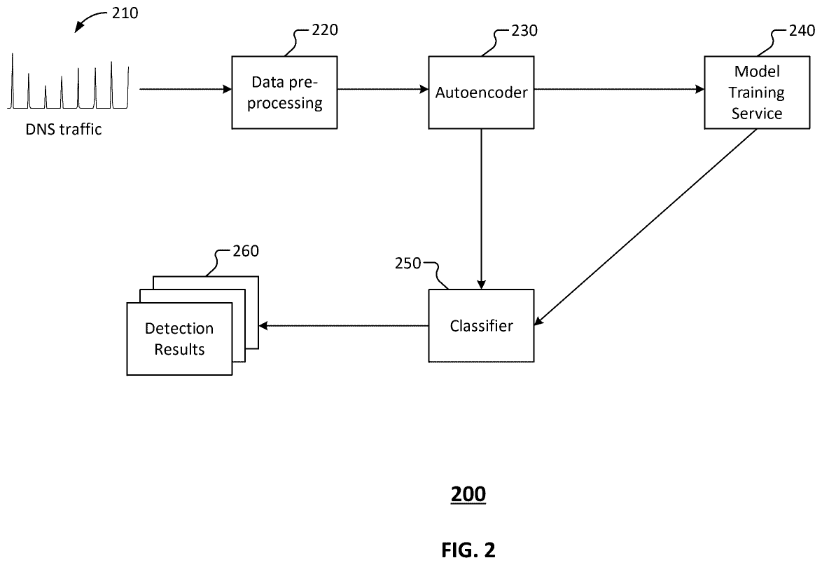

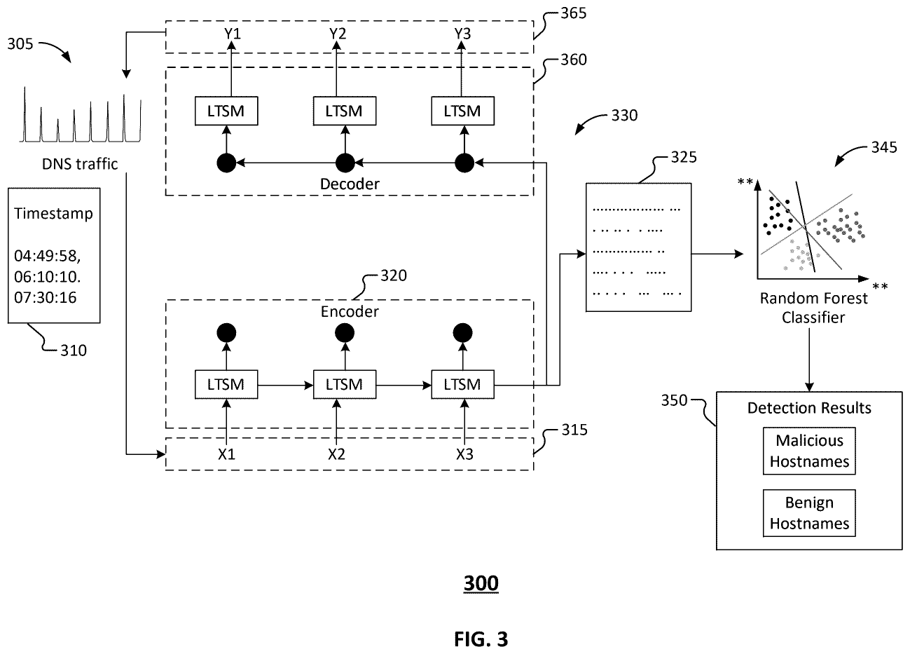

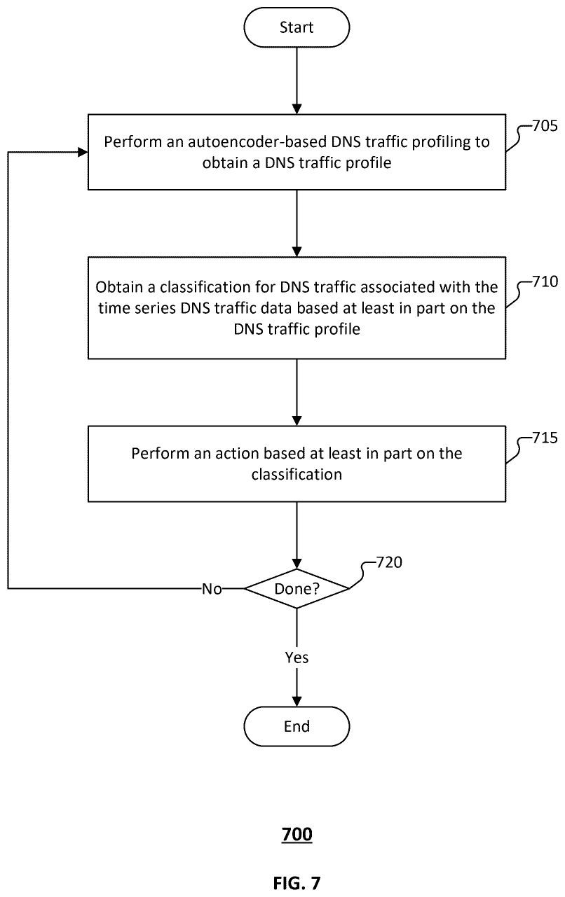

FIG. 1 is a block diagram of an environment for providing a security service to a network according to various embodiments. In some embodiments, system 100 implements at least part of system 200 of FIG. 2 and/or system 300 of FIG. 3. System 100 can implement one or more of processes 700-1500 of FIGS. 7-15.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110. In some embodiments, data appliance 102 is a network edge device. For example, data appliance 102 can implement ION device functionality, security services (e.g., firewall functionality), etc.

Techniques described herein can be used in conjunction with a variety of platforms (e.g., desktops, mobile devices, gaming platforms, embedded systems, etc.) and/or a variety of types of applications (e.g., Android .ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a malicious domain, etc.), classifying DNS response records (e.g., predicting whether a domain IP pair in a DNS response is a DNS hijacked record, etc.), classifying network traffic, classifying DNS traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pen's data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that DNS traffic (e.g., a domain or DNS record comprised in the DNS traffic) is malicious or benign, providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), receive risk signals (e.g., a signal pertaining to an endpoint risk for a network) from one or more other services or products, aggregate a set of risk signals (e.g., to obtain an aggregate risk score or to classify an endpoint), collecting network traffic information (e.g., comprising IP addresses, device information, etc.), determining IP-to-device mappings, filtering the IP-to-device mappings (e.g., for a particular network edge to identify a filtered set of IP-to-device mappings relevant to the particular network edge), distributing to various network edge devices (e.g., data appliance 102) the filtered set of IP-to-device mappings relevant to the various network edge devices, distributing (e.g., to various network edge devices) policies to be enforced at the network edge(s), etc.

In some embodiments, DNS traffic classification is implemented at data appliance 102. For example, data appliance 102 can store a classifier for performing DNS traffic classification and detecting malicious DNS traffic based on the predicted classifications. The classifier may be trained and/or updated by another system or service, such as by security platform 140. For example, security platform 140 can push an update to the classifier for local use by data appliance 102.

In some embodiments, DNS traffic classification is implemented by one or more servers, such as a cloud service. For example, security platform 140 performs the DNS traffic classification. Security platform 140 (e.g., DNS traffic classification service 170) can perform an offline classification, such as based on DNS traffic obtained from DNS traffic logs (e.g., DNS traffic logs stored locally at security entities or reported by the security entities to security platform). Security platform 140 can perform a real-time classification (e.g., contemporaneous with the interception/handling of the DNS traffic), such as based on receiving a query from an inline security entity (e.g., data appliance 102) for a classification.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or DNS traffic classification service 170. Security platform 140 may include various other services/modules, such as a malicious file detector, a malicious traffic detector, a parked domain detector, an application classifier or other traffic classifier, etc.

Network traffic classification service 138 is used in connection with analyzing network traffic (e.g., websites, domains, sample files, etc. pertaining to the network traffic) and/or automatically detecting malicious network traffic.

DNS traffic classification service 170 is used in connection with classifying DNS traffic and/or detecting malicious DNS traffic, such as DNS traffic for phishing attacks, spam email attacks, etc. DNS traffic classification service 170 can perform an offline DNS traffic classification, such as to determine predicted DNS traffic classifications based on historical log data, or real-time DNS traffic classification in response to a query from another security entity (e.g., an inline firewall). In some embodiments, DNS traffic classification service 170 determines the DNS traffic classifications based at least in part on DNS traffic time series data. For example, DNS traffic classification service 170 profiles the DNS traffic time series data to obtain a DNS traffic profile representing the DNS traffic time series data. In response to obtaining the DNS traffic profile, DNS traffic classification service 170 queries a classifier for a predicted DNS traffic classification based on the DNS traffic profile.

In some embodiments, DNS traffic classification service 170 comprises one or more of pre-processing module 172, DNS traffic profiling module 174, DNS traffic profile classification module 176, and/or classifier 178.

DNS traffic classification service 170 obtains DNS traffic to be classified (e.g., for which malicious DNS traffic detections is to be performed) from DNS traffic logs (e.g.., data logs stored at database 160 and/or data logs stored locally at security entities such as inline firewalls) or from queries for DNS traffic classifications such as from inline security entities that are seeking a real-time DNS traffic classification contemporaneous with the interception/handling of DNS traffic.

DNS traffic classification service 170 uses pre-processing module 172 to pre-process DNS traffic. Pre-processing module 172 can pre-process the DNS traffic data before obtaining a predicted DNS traffic classification (e.g., querying a classifier). For example, pre-processing module 172 processes the DNS traffic to obtain pre-processed DNS traffic data with which to query DNS traffic profiling module 174 for determining/obtaining a corresponding DNS traffic profile for use in querying a classifier for a predicted DNS traffic classification. In some embodiments, pre-processing the DNS traffic includes obtaining the DNS traffic time series data for the DNS traffic (e.g., DNS traffic samples for a particular domain or DNS record obtained at different times) and determining a set of time intervals between successive DNS traffic samples of the DNS traffic time series data. The set of time intervals may be determined in accordance with a predefined unit of time, such as seconds. However, various other units of time may be implemented.

In some embodiments, the system (e.g., DNS traffic classification service 170) obtains a DNS traffic profile corresponding to the DNS traffic based at least in part on the set of time intervals for the DNS traffic time series data. For example, the system queries DNS traffic profiling module 174 for the corresponding DNS traffic profile.

In some embodiments, pre-processing module 172 normalizes the time intervals for the DNS traffic time series data. For example, pre-processing module 172 performs a log function with respect to the time intervals in the set of time intervals. The system uses the DNS traffic time series data and the corresponding time interval representations (e.g., log values computed based on the time intervals) to obtain the DNS traffic profile.

DNS traffic classification service 170 uses DNS traffic profiling module 174 to determine DNS traffic profiles based on the DNS traffic for which a DNS traffic classification is to be performed. DNS traffic profiling module 174 determines the DNS traffic profile representing a particular set of DNS traffic time series data based at least in part on the set of time intervals for the DNS traffic. For example, the system determines the DNS traffic profile based at least in part on the DNS traffic data and the set of time intervals or representation of the set of time intervals, such as the result of computing a log function with respect to the time intervals.

In some embodiments, DNS traffic profiling module 174 determines the DNS traffic profiling by querying an autoencoder based at least in part on the DNS traffic data, such as by the pre-processed data obtained by pre-processing module 172. For example, the DNS traffic profiling module 174 inputs the pre-processed data to the autoencoder which generates a corresponding DNS traffic profile.

DNS traffic classification service 170 uses DNS traffic profile classification module 176 to obtain a DNS traffic classification based at least in part on the DNS traffic, for example, based on the DNS traffic profile obtained by DNS traffic profiling module 174. DNS traffic profile classification can obtain the DNS traffic classification based on querying classifier 178 using the DNS traffic profile.

In some embodiments, classifier 178 returns a predicted DNS traffic classification. The predicted DNS traffic classification may include an indication of a likelihood that the DNS traffic is malicious DNS traffic. DNS traffic profile classification module 176 can determine the DNS traffic classification based at least in part on the predicted DNS traffic classification obtained by the classifier 178. For example, DNS traffic profile classification module 176 determines the DNS traffic classification (e.g., whether the DNS traffic is malicious) based on comparing predicted DNS traffic classification (e.g., the indication of a likelihood that the DNS traffic is malicious DNS traffic) to a predefined threshold (e.g., a likelihood threshold). If the predicted DNS traffic classification satisfies the predefined threshold (e.g., exceeds the likelihood threshold), the DNS traffic profile classification module 176 determines the DNS traffic classification to be that the DNS traffic is malicious. Conversely, if the predicted DNS traffic classification does not satisfy the predefined threshold, the DNS traffic profile classification module 176 determines the DNS traffic classification to be that the DNS traffic is not malicious (e.g., the DNS traffic is benign).

Examples of machine learning processes that can be implemented in connection with training the classifier 178 include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc. In some embodiments, the classifier 178 implements a model trained based on implementing random forest process. Various other types of machine learning techniques may be implemented.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, or whether a DNS record is DNS hijacked), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, a website content, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process. The classifier may be trained using one or more of the machine learning techniques described for classifier 178.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic, system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains or having certain characteristics/profiles is to be blocked and network traffic associated with other domains or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed network traffic sample for a particular session), security platform 140 (e.g., network traffic classification service 138) sends an indication that network activity (e.g., other network traffic samples) associated with the session for which the network traffic sample is obtained are associated with, or otherwise correspond to, the determined classification. In the case that the determined classification for the network traffic sample is that the corresponding network sample (e.g., a file extracted from the network traffic) or network traffic/activity is malicious network traffic/activity, security platform 140 provides an indication that network traffic/activity associated with the session for which the network traffic sample is obtained is also to be handled according to whether the network traffic sample is malicious. Security platform 140 can provide an indication that network traffic matching the network traffic sample predicted to be malicious is to be handled as a malicious network traffic. For example, security platform 140 determines (e.g., computes) a signature or identifier for the network traffic/activity (e.g., a hash or other signature, or identifier for the corresponding network session), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www. example. com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system to perform DNS traffic classifications according to various embodiments. In some embodiments, system 200 implements at least part of system 100 of FIG. 1 and/or system 300 of FIG. 3. For example, system 200 can implement the DNS traffic classification service 170 of system 100. System 200 can implement one or more of processes 700-1500 of FIGS. 7-15.

In the example shown, system 200 obtains DNS traffic data 210. The DNS traffic data 210 can be obtained from traffic logs and/or from inline security entities or network services. In some embodiments, the DNS traffic data 210 comprises time series data (e.g., DNS traffic time series data). For example, the DNS traffic time series data comprises DNS traffic data sampled at a set of different time periods. The time intervals between the DNS traffic data samples can be used in connection with determining whether the DNS traffic is malicious.

In response to receiving the DNS traffic data 210, at 220, system 200 pre-processes the DNS traffic data to obtain pre-processed DNS traffic data. In some embodiments, the pre-processing the DNS traffic data includes determining time intervals between successive DNS traffic data samples. For example, system 200 determines a set of time intervals associated with the DNS traffic data. System 200 may determine a DNS traffic classification based at least in part on the set of time intervals associated with the DNS traffic data.

In some embodiments, the pre-processing the DNS traffic data 210 includes determining the time intervals between successive DNS data traffic samples and computing a log function with respect to each time interval (e.g., to obtain a representative logarithmic value for the time interval). System 200 may determine a DNS traffic classification based at least in part on the DNS traffic data and the output from computing the log function with respect to the time intervals in the set of time intervals for DNS traffic samples within DNS traffic data 210.

System 200 inputs the pre-processed DNS traffic data (e.g., the DNS traffic and the output from computing the log function with respect to time intervals between successive samples in the DNS traffic data 210) to autoencoder 230 to obtain a DNS traffic profile corresponding to DNS traffic data 210. For example, autoencoder 230 generates the DNS traffic profile based at least in part on the DNS traffic data and the set of time intervals between DNS traffic samples in DNS traffic data 210 (e.g., the output from computing the log function with respect to time intervals between successive samples in the DNS traffic data 210).

System 200 provides the DNS traffic profile to model training service 240 in connection with training or updating (e.g., retraining) classifier 250. For example, system 200 inputs a set of DNS traffic profiles as a training set for model training service 240 to use in training/updating a classifier. Model training service 240 implements a machine learning technique to obtain classifier 250. Examples of machine learning processes that can be implemented in connection with training the classifier 250 include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc. In some embodiments, the classifier 250 implements machine learning model trained using a random forest technique. Various other types of machine learning techniques may be implemented.

In response to training classifier 250, system 200 can implement classifier 250 in connection with performing DNS traffic classifications. For example, when system 200 determines that a DNS traffic classification is to be performed (e.g., based on receiving a query for a DNS traffic classification, such as from an inline security entity), system 200 provides the corresponding DNS traffic profile generated by autoencoder 230 to classifier 250. Classifier 250 determines the DNS traffic classification based at least in part on the DNS traffic profile. For example, the DNS traffic profile may correspond to a representation of the DNS traffic data 210 and the temporal data associated therewith, such as the time intervals between successive DNS traffic samples or a result of computing a log function with respect to such time intervals. Classifier 250 can output the DNS traffic classifications, such as by outputting the DNS traffic classification as a detection result (e.g., an indication of whether the DNS traffic is malicious, or an indication that a malicious DNS traffic sample is detected), or storing the DNS traffic classification into a set of detection results 260. The detection results can be used by model training service 240 in connection with updating or re-training the classifier.

FIG. 3 is a block diagram of a system to perform DNS traffic classifications according to various embodiments. In some embodiments, system 300 implements at least part of system 100 of FIG. 1 and/or system 200 of FIG. 2. For example, system 300 can implement the DNS traffic classification service 170 of system 100. System 300 can implement one or more of processes 700-1500 of FIGS. 7-15.

System 300 obtains DNS traffic 305. For example, system 300 can obtain the DNS traffic 305 from traffic logs and/or from an inline security entity. The DNS traffic 305 can correspond to DNS traffic data for a particular hostname from a particular device (e.g., endpoint), such as over a predefined period of time (e.g., the period of time over which the DNS traffic data is collected may be configurable, for example, by an administrator). According to various embodiments, the DNS traffic 305 comprises time information. For example, the DNS traffic 305 comprises timestamp information 310 storing timestamps for each DNS traffic sample comprised in the DNS traffic 305.

In some embodiments, the timestamp information 310 stores time associated with the DNS traffic sample. For example, the timestamp information 310 may correspond to a timestamp of a time at which the DNS traffic sample is received/intercepted, a time at which the DNS traffic sample originated at the source, a time at which the DNS traffic sample is stored in a traffic log, etc.

In response to receiving DNS traffic 305 (e.g., and determining to perform a DNS traffic classification) system 300 pre-processes the DNS traffic 305. The pre-processing the DNS traffic 305 includes obtaining the timestamp information 310 for DNS traffic 305. In some embodiments, the pre-processing the DNS traffic 305 includes determining time intervals between successive DNS traffics samples in DNS traffic 305 based at least in part on the timestamp information 310. The time intervals between successive DNS traffics samples can be stored in a set of time intervals.

In some embodiments, system 300 determines (e.g., by using an autoencoder) the DNS traffic profile directly based at least in part on the time intervals between successive DNS traffic samples in the DNS traffic 305.

In some embodiments, the pre-processing the DNS traffic 305 further includes performing (e.g., computing) a predefined log function with respect to the timestamp information 310. For example, system 300 computes the log function with respect each time interval in the set of time intervals for the DNS traffic 305.

System 300 uses autoencoder 330 to generate a DNS traffic profile 325 based at least in part on the DNS traffic data and the timestamp information 310 (e.g., the results of computing the log function with respect to the set of time intervals). According to various embodiments, autoencoder 330 comprises an encoder 320 and a decoder 360. Autoencoder 330 may additionally comprise (i) input layer 315 via which DNS traffic 305, or the pre-processed DNS traffic data, is input, and (ii) output layer 364 via which an output from decoder 360 (e.g., the decoded DNS traffic profile) is output.

In the example shown, the pre-processed DNS traffic data (e.g., the DNS traffic 305 and output from computing the log function with respect to the set of time intervals) to an input layer 315 of autoencoder. Input layer 315 processes this input data and provides the data to the encoding layers, which may comprise a plurality of LSTMs.

According to various embodiments, the autoencoding process includes transforming DNS traffic time series data into compressed, fixed-dimensional representations (e.g., DNS traffic profiles) while preserving critical patterns and temporal characteristics. Autoencoder 330 autoencoder comprises an encoder 320 and a decoder 360. The encoder 320 processes the input data (e.g., the DNS traffic time series data) and compresses it into a representation (e.g., the DNS traffic profile 325), while the decoder 360 attempts to reconstruct the original data from this compressed representation. The autoencoder 330 is trained in connection with minimizing reconstruction loss, which is the difference between the original input (e.g., the DNS traffic data) and the reconstructed output (e.g., the output from decoding the DNS traffic profile). By learning to encode and decode the data effectively, system 300 generates DNS traffic profiles that encapsulate the most relevant features of the input DNS traffic time series data.

In some embodiments, system 300 implements an RNN Autoencoder. An RNN autoencoder is particularly well-suited for processing sequential data, such as DNS traffic time series, due to its ability to capture temporal dependencies and patterns. The RNN autoencoder comprises an RNN-based encoder and decoder.
Encoder: The encoder processes the input time series data sequentially, step by step, using RNN cells. As each data point in the sequence is fed into the encoder, it updates its hidden state to incorporate information from the current and previous data points. This process condenses the entire time series into a fixed-dimensional latent vector (e.g., the DNS traffic profile), representing the encoded features of the sequence.
Decoder: The decoder takes the latent vector (e.g., the DNS traffic profile) from the encoder as input and generates a reconstructed version of the time series. The decoder sequentially outputs one data point at a time, conditioned on the latent vector and the previously decoded data points. The decoder's goal is to reproduce the input sequence as closely as possible.
Training: During training, the autoencoder optimizes a loss function that measures the reconstruction error (e.g., mean squared error) between the input sequence and the reconstructed output. This process trains the encoder to create an effective latent representation and the decoder to reconstruct the input from this representation.

In some embodiments, the system implements a Long Short-Term Memory (LSTM) encoder. An LSTM encoder is a specialized type of RNN encoder designed to address the limitations of standard RNNs, such as vanishing or exploding gradients, by effectively capturing long-term dependencies in sequential data.
LSTM Encoder Architecture: The LSTM encoder replaces standard RNN cells with LSTM cells. Each LSTM cell comprises three gates: the input gate, forget gate, and output gate. These gates regulate the flow of information through the network, allowing the model to retain relevant information from earlier time steps while discarding less important data. The LSTM cell's internal memory, or cell state, is updated at each time step to store long-term dependencies.
Encoding Process: The LSTM encoder receives the DNS traffic time series data as input, processing it sequentially one data point at a time. For each time step, the LSTM cell updates its cell state and hidden state based on the current input and the previous states. After processing the entire sequence, the final hidden state of the LSTM cell is extracted as the fixed-dimensional latent representation of the input time series. This latent vector, which serves as the DNS traffic profile, captures both temporal and contextual features of the traffic.
The LSTM encoder's ability to capture long-term dependencies is particularly valuable in detecting patterns in DNS traffic, which may involve subtle correlations over extended periods. For example, the system can detect malicious behavior that unfolds over multiple DNS queries or responses by encoding these temporal patterns into the DNS traffic profile.
Integration with the Decoder: The DNS traffic profile generated by the LSTM encoder is passed to the decoder for reconstruction. The decoder, which may also use LSTM cells, attempts to generate the original time series from the DNS traffic profile. The training process ensures that the encoder's output (e.g., the DNS traffic profile) preserves the most critical features of the input data.

According to various embodiments through the use of an LSTM encoder, the system effectively transforms variable-length DNS traffic time series data into fixed-dimensional DNS traffic profiles that encapsulate essential temporal and contextual information. This approach significantly enhances the system's capacity to classify DNS traffic with high precision, providing robust detection of both benign and malicious traffic patterns.

In addition to, or as an alternative to, the RNN-based autoencoder, several other types of autoencoders can be implemented in this invention to process and encode DNS traffic profiles. Examples of other types of autoencoders that can be implemented include (a) convolutional autoencoder, (b) a variational autoencoder (VAE), (c) a denoising autoencoder, (d) stacked autoencoder, and/or (e) a sparse autoencoders. Various other encoding/decoding techniques may be implemented.

A convolutional autoencoder can be implemented to process DNS traffic data, particularly if the data can be represented in a spatial or structured format. This type of autoencoder uses convolutional layers to extract spatially localized patterns in the input data. Although convolutional autoencoders are typically used for image data, their ability to capture local dependencies could be adapted for DNS traffic features, especially when patterns in the traffic exhibit spatial-like characteristics when arranged in matrices or graphs. The compressed latent representation generated by the convolutional encoder can then be used to classify DNS traffic.

Another approach is the use of a variational autoencoder (VAE). VAEs not only encode input data into a latent space but also impose a probabilistic structure on this space. This means the VAE learns a distribution over the latent representations rather than deterministic points, allowing the system to capture uncertainties or variances in DNS traffic patterns. This probabilistic modeling can be particularly useful in identifying outliers or anomalies, which are often indicative of malicious activity. By generating latent vectors (e.g., DNS traffic profiles) that reflect the statistical properties of benign DNS traffic, the VAE enables robust differentiation between normal and abnormal traffic profiles.

A denoising autoencoder can also be implemented to enhance the system's resilience to noise or incomplete data. Denoising autoencoders are trained to reconstruct the original input data from corrupted or noisy versions of it. This capability is particularly valuable in environments where DNS traffic logs may be incomplete or contain errors due to network anomalies. By learning to extract meaningful representations even in the presence of noise, the denoising autoencoder can improve the robustness and reliability of the DNS traffic profiles used for classification.

A stacked autoencoder, which combines multiple layers of encoding and decoding, can further enhance feature extraction by learning hierarchical representations of the DNS traffic. Each successive layer in the encoder learns increasingly abstract features, allowing the system to capture complex patterns and correlations that may not be apparent in the raw data. This hierarchical feature extraction is especially advantageous when analyzing large-scale DNS traffic with intricate dependencies.

According to various embodiments, the system (e.g., the autoencoder in the system) can be configured to implement diverse types of autoencoders to adapt to various challenges in DNS traffic analysis. Each type of autoencoder provides a unique way of capturing and encoding the underlying characteristics of DNS traffic, enabling the system to address a wide range of threats and operational requirements.

According to various embodiments, system 300 comprises a classifier 345, such as a random forest classifier or a decision tree classifier, that processes the DNS traffic profiles 325 generated by the autoencoder to distinguish between malicious and benign DNS traffic. These DNS traffic profiles 325 can serve as feature-rich, fixed-dimensional representations of the original time series data, encapsulating both the content and temporal characteristics of the DNS traffic. The classifier 345 is trained to recognize patterns within these DNS traffic profiles 325 that are indicative of either normal or suspicious behavior.

During classification, the DNS traffic profiles 325 are used as inputs to the classifier 345, for example, a machine learning model. In the case of a decision tree classifier, the model evaluates the DNS traffic profiles 325 through a hierarchical series of decision nodes, where each node represents a condition based on a specific feature in the profile. By traversing the tree from the root to a leaf node, the model assigns the DNS traffic to a class, either malicious or benign, based on the conditions satisfied along the path.

In some embodiments, system 300 implements a random forest classifier, which can enhance the decision tree approach by constructing an ensemble of decision trees. Each tree in the random forest is trained on a subset of the training data and features, introducing diversity among the trees. During classification, a DNS traffic profile is evaluated by all the trees in the forest. Each tree produces a classification result, and the final classification is determined by aggregating the results, typically through majority voting. This ensemble approach can improve the classifier's robustness, reduce overfitting, and enhance its ability to generalize to unseen data.

The effectiveness of classifier 345 is largely determined by the quality of the training data and/or the features encoded in the DNS traffic profiles 325. During training, the model is exposed to labeled examples of DNS traffic, including both benign and malicious samples. The training process adjusts the model's parameters to minimize classification errors, enabling it to learn patterns and correlations that distinguish between the two classes. For example, the classifier 345 may identify characteristics such as unusual query frequencies, irregular timing patterns, or known malicious domain features encoded in the profiles.

According to various embodiments, once trained, the classifier 345 can be deployed, such as to operate in real-time or near real-time to analyze incoming DNS traffic profiles 325 (e.g., DNS traffic profiles obtained by encoding intercepted DNS traffic, etc.). By evaluating the DNS traffic profile(s), the classifier 345 can quickly and accurately determine whether the traffic exhibits patterns consistent with malicious behavior. For example, the classifier can correspondingly classify the DNS traffic 305 as malicious (or benign) based on the corresponding DNS traffic profile. This determination allows the system to flag potential threats for further investigation or take immediate action, such as blocking access to malicious domains.

In some embodiments, the classifier 345 can be updated to adapt the classifier 345 to evolving traffic patterns and recognize complex indicators of malicious activity, thereby making the classifier a powerful tool for enhancing network security.

In response to determining the predicted DNS traffic classification, classifier 345 outputs detection results 350. For example, classifier 345 outputs a DNS traffic classification as an indication that the DNS traffic 305 corresponds to a malicious hostname or a benign hostname.

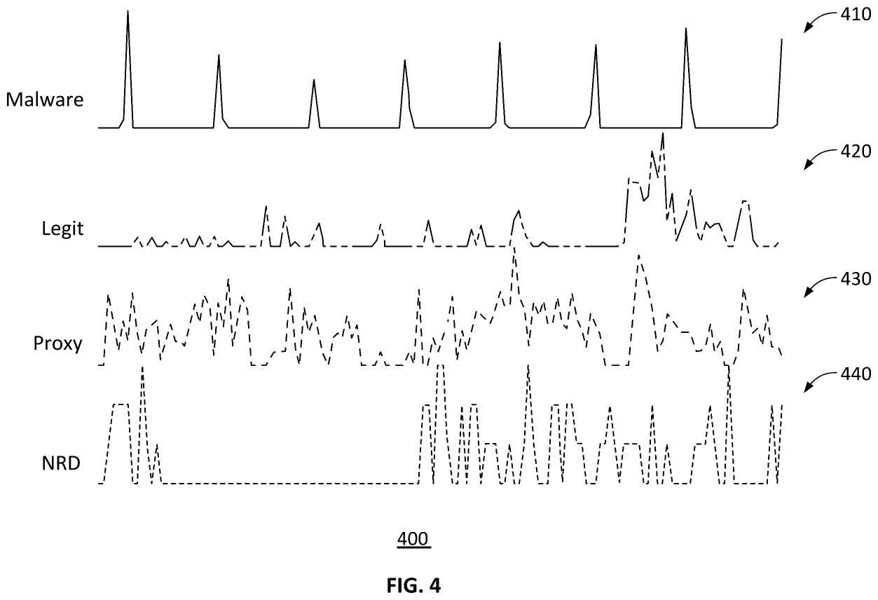

FIG. 4 is an illustration of examples of time series data for various DNS traffic types. In the example shown, illustration 400 comprises juxtaposes representative examples of DNS traffic time series data for a malware sample 410, a legitimate traffic sample 420 (e.g., DNS traffic that is non-malicious/benign), a proxy 430, and a newly registered domain (NRD) 440. As shown in the example, the malware sample 410 has a distinct DNS traffic time series data profile. The DNS traffic time series data for malware sample 410 includes very sparse activity. For example, DNS traffic time series data for malware sample 410 includes very sharp or high intensity spikes in DNS traffic activity separated by no/low activity for relatively long periods of time.

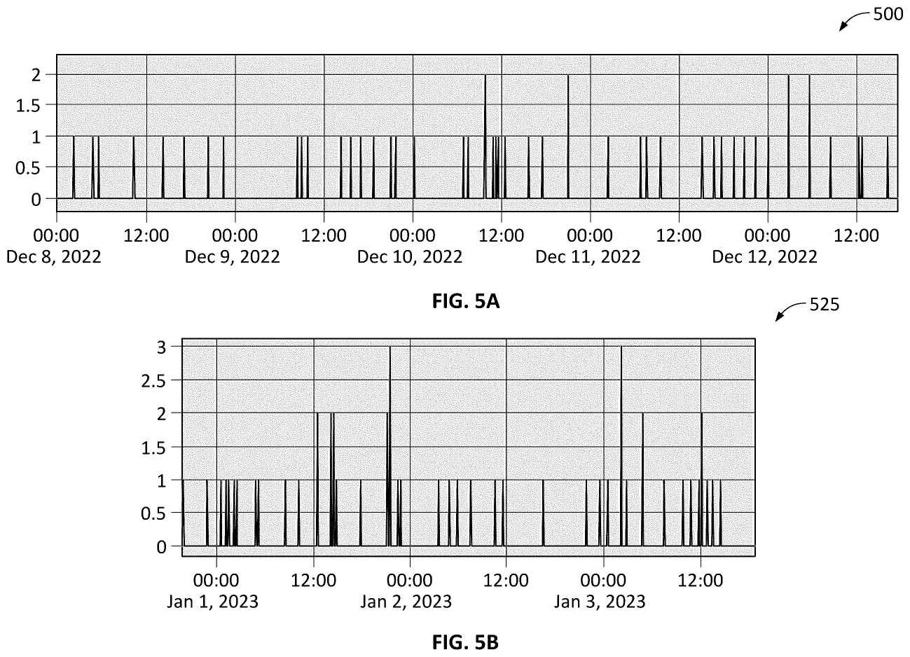

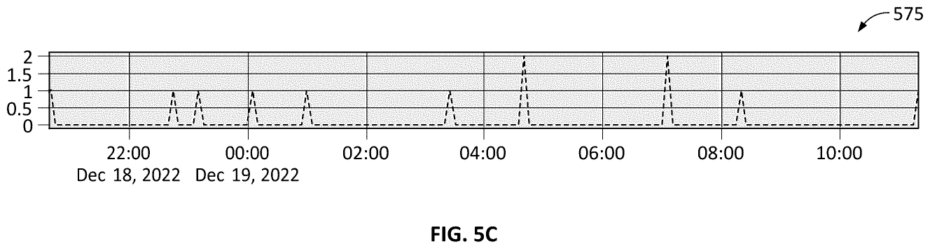

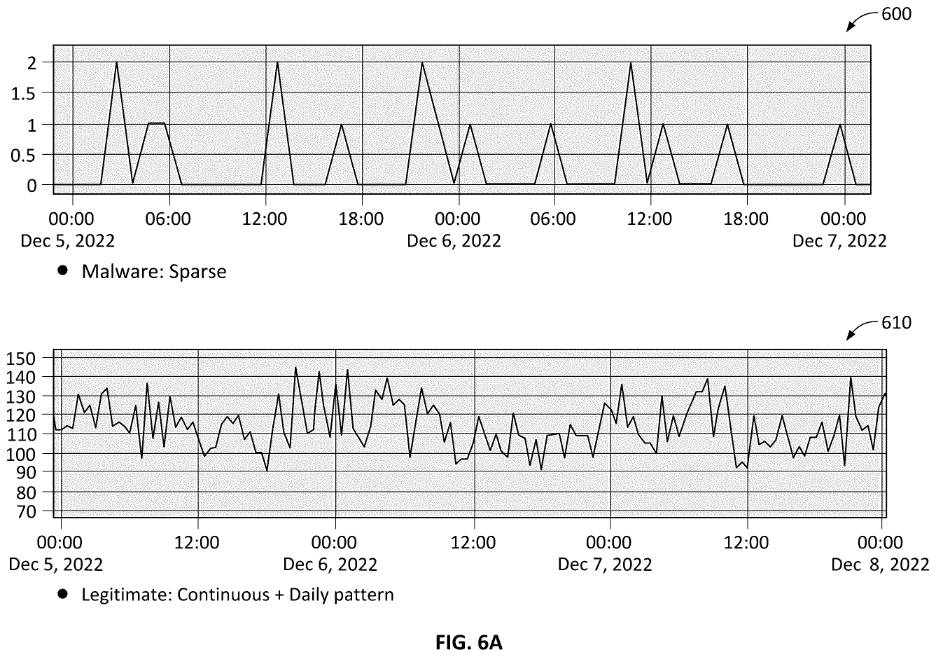

FIG. 5A is an illustration of an example of time series data for DNS traffic associated with a phishing attack. In the example shown, DNS traffic sample 500 for a phishing attack follows the distinct DNS traffic time series data profile for malicious network activity. The DNS traffic time series data for the phishing attack sample includes very sparse activity. For example, DNS traffic time series data for the phishing attack includes very sharp or high intensity spikes in DNS traffic activity separated by no/low activity for relatively long periods of time.

FIG. 5B is an illustration of an example of time series data for DNS traffic associated with a spam email attack. In the example shown, DNS traffic sample 525 for a spam email attack follows the distinct DNS traffic time series data profile for malicious network activity. The DNS traffic time series data for the spam email attack sample includes very sparse activity. For example, DNS traffic time series data for the spam email attack includes very sharp or high intensity spikes in DNS traffic activity separated by no/low activity for relatively long periods of time.

FIG. 5C is an illustration of an example of time series data for DNS traffic associated with a squatting domain attack. In the example shown, DNS traffic sample 575 for a squatting domain attack follows the distinct DNS traffic time series data profile for malicious network activity. The DNS traffic time series data for the squatting domain attack sample includes very sparse activity. For example, DNS traffic time series data for the squatting domain attack includes very sharp or high intensity spikes in DNS traffic activity separated by no/low activity for relatively long periods of time.

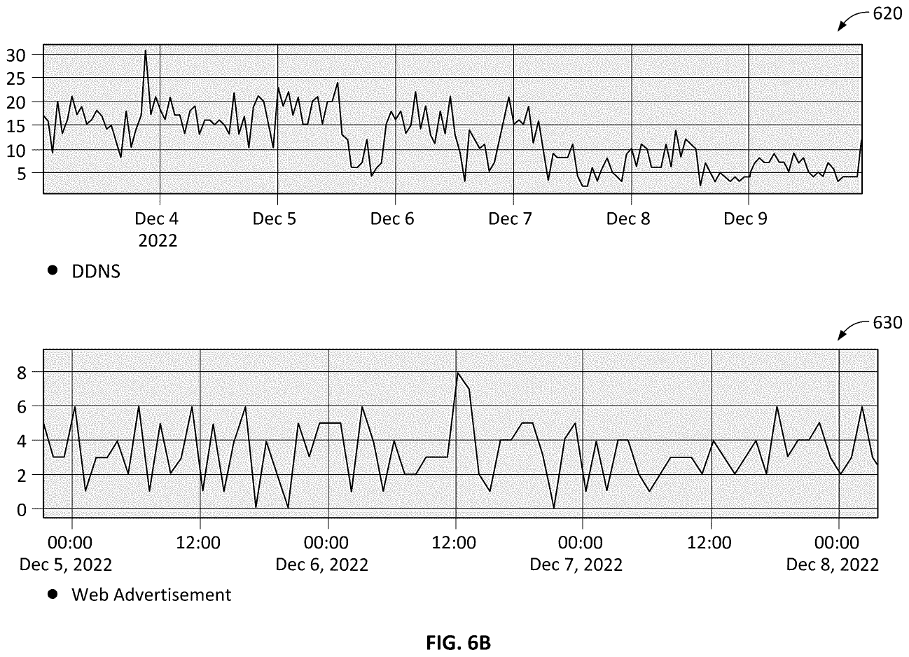

FIGS. 6A and 6B are illustrations of representative examples of time series data for DNS traffic. In the example shown, DNS traffic sample 600 for malware follows the distinct DNS traffic time series data profile for malicious network activity. The DNS traffic time series data for the squatting domain attack sample includes very sparse activity. For example, DNS traffic time series data for the squatting domain attack includes very sharp or high intensity spikes in DNS traffic activity separated by no/low activity for relatively long periods of time. In contrast, DNS traffic sample 610 for legitimate traffic exhibits a more continuous flow of DNS traffic, which may include daily patterns. Similarly, DNS traffic sample 620 for DNS traffic exhibits a more continuous flow of DNS traffic, and DNS traffic sample 630 for a web advertisement provides more continuous and less sparse DNS traffic as compared to DNS traffic time series.

FIG. 7 is a flow diagram of a method for detecting malicious DNS traffic based at least in part on a DNS traffic profile according to various embodiments. According to various embodiments, process 700 is implemented at least in part by one or more of system 100 of FIG. 1, system 200 of FIG. 2, and/or system 300 of FIG. 3.

In some embodiments, process 700 is implemented by a cloud service (e.g., one or more servers) that provides DNS traffic classification services and/or other network security services to various network endpoints or security entities. For example, the system may implement process 700 to perform offline detections based on historical DNS traffic samples obtained from traffic logs. As another example, the system may implement process 700 contemporaneous with interception/handling of DNS traffic. An inline security entity provides to the system an intercepted DNS traffic sample for a real-time (e.g., near real-time) classification and the system implements process 700 contemporaneous with the security entity's handling of the DNS traffic.

At 705, the system performs an autoencoder-based DNS traffic profiling to obtain a DNS traffic sample. At 710, the system obtains a classification for DNS traffic associated with the time series DNS traffic data based at least in part on the DNS traffic profile. At 715, the system performs an action based at least in part on the classification. At 720, a determination is made as to whether process 700 is complete. In some embodiments, process 1200 is determined to be complete in response to a determination that no further DNS traffic is to be classified, an allocated time for performing the DNS traffic classification has elapsed (e.g., in the case of a real-time or inline detection) an administrator indicates that process 700 is to be paused or stopped, etc. In response to a determination that process 700 is complete, process 700 ends. In response to a determination that process 700 is not complete, process 700 returns to 705.

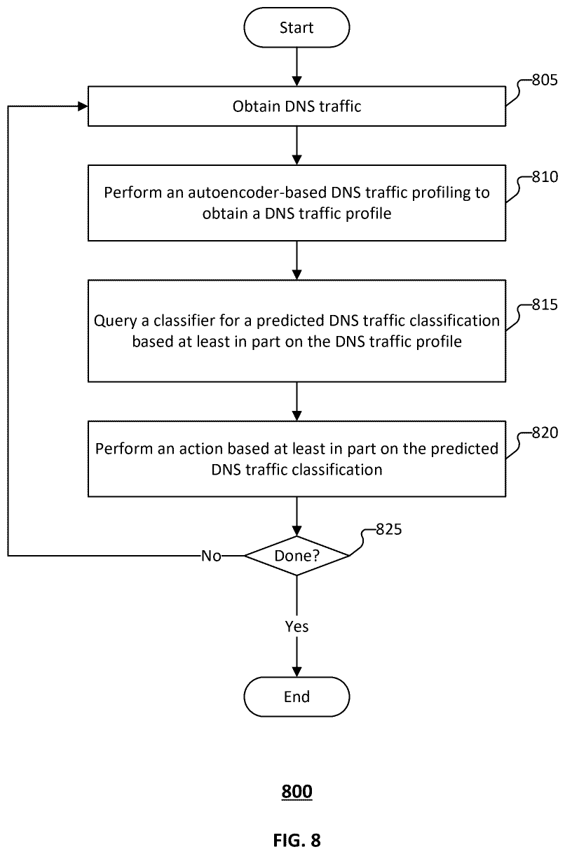

FIG. 8 is a flow diagram of a method for detecting malicious DNS traffic based at least in part on a DNS traffic profile according to various embodiments. According to various embodiments, process 800 is implemented at least in part by one or more of system 100 of FIG. 1, system 200 of FIG. 2, and/or system 300 of FIG. 3.

In some embodiments, process 800 is implemented by a cloud service (e.g., one or more servers) that provides DNS traffic classification services and/or other network security services to various network endpoints or security entities. For example, the system may implement process 800 to perform offline detections based on historical DNS traffic samples obtained from traffic logs. As another example, the system may implement process 800 contemporaneous with interception/handling of DNS traffic. An inline security entity provides to the system an intercepted DNS traffic sample for a real-time (e.g., near real-time) classification and the system implements process 800 contemporaneous with the security entity's handling of the DNS traffic.

At 805, the system obtains DNS traffic. In some embodiments, the system obtains the DNS traffic based on interception of the DNS traffic. For example, the system may be a cloud service that receives the DNS traffic sample(s) from a security entity, such as an inline firewall. As another example, the system may be implemented at an inline security entity and obtains the DNS traffic based on interception of DNS traffic passing through the inline security entity. As another example, the system obtains the DNS traffic samples from a collection of DNS traffic logs, such as in connection with performing an offline DNS traffic classification.

At 810, the system performs an autoencoder-based DNS traffic profiling to obtain a DNS traffic profile. The DNS traffic profile is determined based at least in part on the obtained DNS traffic. For example, the system queries the autoencoder based on the DNS traffic and obtains the DNS traffic profile based at least in part on the response from the autoencoder. At 815, the system obtains a classification for DNS traffic associated with the time series DNS traffic data based at least in part on the DNS traffic profile.

At 820, the system performs an action based at least in part on the classification.

At 820, a determination is made as to whether process 800 is complete. In some embodiments, process 800 is determined to be complete in response to a determination that no further DNS traffic is to be classified, an allocated time for performing the DNS traffic classification has elapsed (e.g., in the case of a real-time or inline detection) an administrator indicates that process 800 is to be paused or stopped, etc. In response to a determination that process 800 is complete, process 800 ends. In response to a determination that process 800 is not complete, process 800 returns to 805.

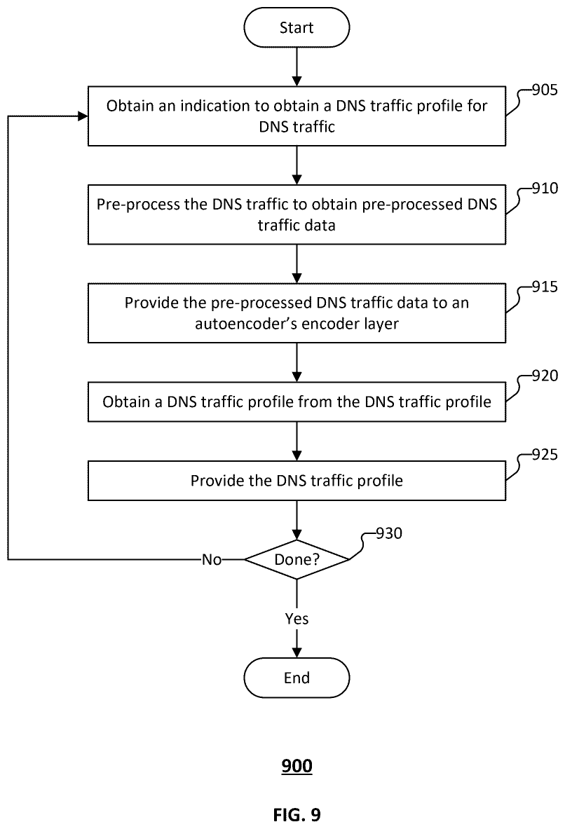

FIG. 9 is a flow diagram of a method for obtaining a DNS traffic profile based at least in part on intercepted DNS traffic according to various embodiments. According to various embodiments, process 900 is implemented at least in part by one or more of system 100 of FIG. 1, system 200 of FIG. 2, and/or system 300 of FIG. 3.

In some embodiments, process 900 is implemented by a cloud service (e.g., one or more servers) that provides DNS traffic classification services and/or other network security services to various network endpoints or security entities. For example, the system may implement process 900 to perform offline detections based on historical DNS traffic samples obtained from traffic logs. As another example, the system may implement process 900 contemporaneous with interception/handling of DNS traffic. An inline security entity provides to the system an intercepted DNS traffic sample for a real-time (e.g., near real-time) classification and the system implements process 900 contemporaneous with the security entity's handling of the DNS traffic.

At 905, the system obtains an indication to obtain a DNS traffic profile for DNS traffic. At 910, the system pre-processes the DNS traffic to obtain pre-processed DNS traffic data. For example, the system determines time intervals between DNS traffic samples within the DNS traffic time series data. In some embodiments, process 900 invokes process 1000 and/or process 1100 to obtain the pre-processed DNS traffic data. At 915, the system provides the pre-processed DNS traffic data to an autoencoder's encoder layer. For example, the system queries the autoencoder for a corresponding DNS traffic profile. At 920, the system obtains a DNS traffic profile from the DNS traffic profile. At 925, the system provides the DNS traffic profile. At 930, a determination is made as to whether process 900 is complete. In some embodiments, process 900 is determined to be complete in response to a determination that no further DNS traffic is to be classified, an allocated time for performing the DNS traffic classification has elapsed (e.g., in the case of a real-time or inline detection), no further DNS traffic is to be handled, an administrator indicates that process 900 is to be paused or stopped, etc. In response to a determination that process 900 is complete, process 900 ends. In response to a determination that process 900 is not complete, process 900 returns to 905.

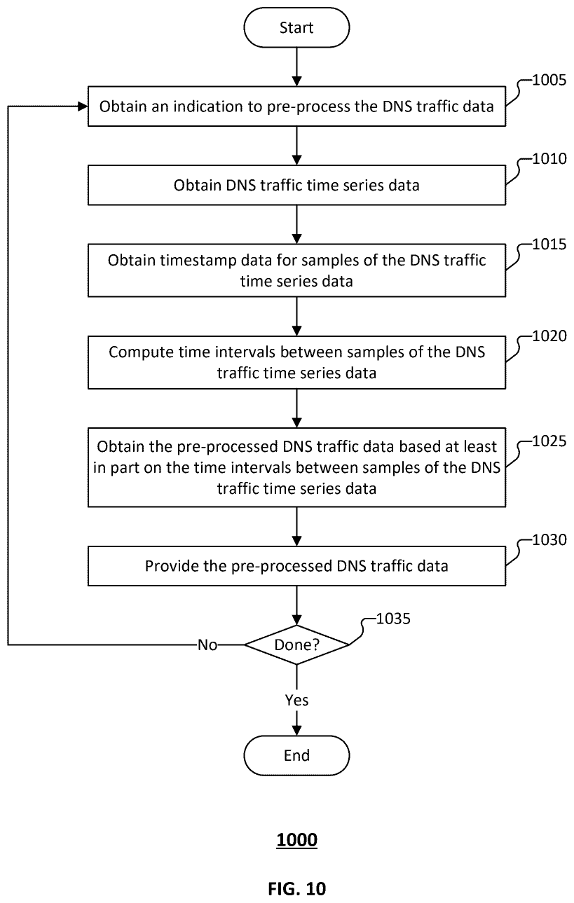

FIG. 10 is a flow diagram of a method for obtaining pre-processed DNS traffic based at least in part on intercepted DNS traffic according to various embodiments. According to various embodiments, process 1000 is implemented at least in part by one or more of system 100 of FIG. 1, system 200 of FIG. 2, and/or system 300 of FIG. 3.

In some embodiments, process 1000 is implemented by a cloud service (e.g., one or more servers) that provides DNS traffic classification services and/or other network security services to various network endpoints or security entities. For example, the system may implement process 1000 to perform offline detections based on historical DNS traffic samples obtained from traffic logs. As another example, the system may implement process 1000 contemporaneous with interception/handling of DNS traffic. An inline security entity provides to the system an intercepted DNS traffic sample for a real-time (e.g., near real-time) classification and the system implements process 1000 contemporaneous with the security entity's handling of the DNS traffic.

In some embodiments, process 1000 is invoked by process 700 (e.g., at 705), process 800 (e.g., at 810), and/or 900 (e.g., at 910).

At 1005, the system obtains an indication to pre-process the DNS traffic data. At 1010, the system obtains DNS traffic time series data. For example, the DNS traffic time series data pertains to a particular domain or DNS record. At 1015, the system obtains timestamp data for samples of the DNS traffic time series data. At 1020, the system computes time intervals between samples of the DNS traffic time series data. At 1025, the system obtains pre-processed DNS traffic based at least in part on the time intervals between samples of the DNS traffic time series data. For example, the system obtains the DNS traffic time series data comprising an indication of time intervals between DNS traffic samples. At 1030, the system provides the pre-processed DNS traffic data. In some embodiments, the system provides the pre-processed DNS traffic data to the other system, service, or process that invoked process 1000. At 1035, a determination is made as to whether process 1000 is complete. In some embodiments, process 1000 is determined to be complete in response to a determination that no further DNS traffic is to be classified, an allocated time for performing the DNS traffic classification has elapsed (e.g., in the case of a real-time or inline detection) an administrator indicates that process 1000 is to be paused or stopped, etc. In response to a determination that process 1000 is complete, process 1000 ends. In response to a determination that process 1000 is not complete, process 1000 returns to 1005.

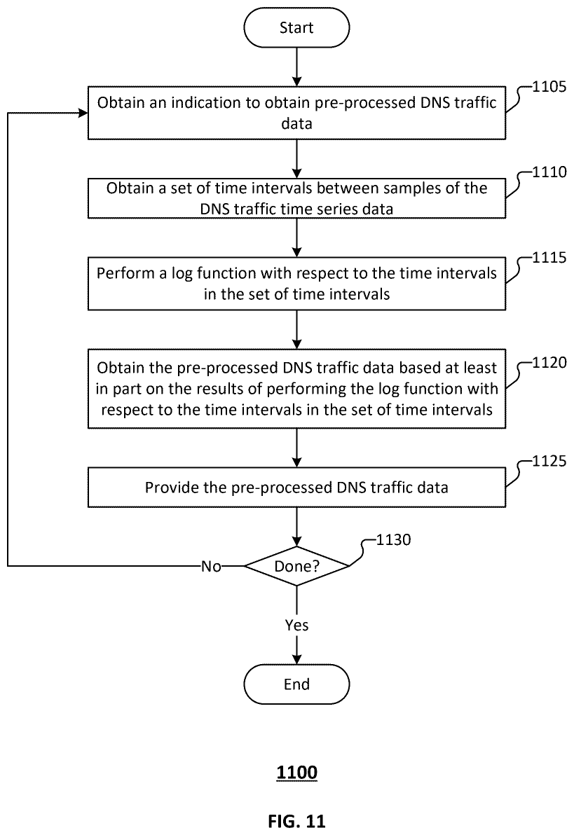

FIG. 11 is a flow diagram of a method for obtaining pre-processed DNS traffic based at least in part on intercepted DNS traffic according to various embodiments. According to various embodiments, process 1100 is implemented at least in part by one or more of system 100 of FIG. 1, system 200 of FIG. 2, and/or system 300 of FIG. 3.

In some embodiments, process 1100 is implemented by a cloud service (e.g., one or more servers) that provides DNS traffic classification services and/or other network security services to various network endpoints or security entities. For example, the system may implement process 1100 to perform offline detections based on historical DNS traffic samples obtained from traffic logs. As another example, the system may implement process 1100 contemporaneous with interception/handling of DNS traffic. An inline security entity provides to the system an intercepted DNS traffic sample for a real-time (e.g., near real-time) classification and the system implements process 1100 contemporaneous with the security entity's handling of the DNS traffic.

In some embodiments, process 1100 is invoked by process 700 (e.g., at 705), process 800 (e.g., at 810), and/or 900 (e.g., at 910).

At 1005, the system obtains an indication to obtain pre-processes the DNS traffic data. At 1110, the system obtains a set of time intervals between samples of the DNS traffic time series data. For example, the system obtains timestamp data for samples of the DNS traffic time series data and computes time intervals between successive samples of the DNS traffic time series data and stores the time intervals in the set of time intervals. At 1115, the system performs a log function with respect to the time intervals in the set of time intervals. At 1120, the system obtains pre-processed DNS traffic based at least in part on the results of performing the log function with respect to the time intervals int eh set of time intervals. For example, the system obtains the DNS traffic time series data comprising an indication of a logarithm for the time intervals between successive DNS traffic samples. At 1125, the system provides the pre-processed DNS traffic data. In some embodiments, the system provides the pre-processed DNS traffic data to the other system, service, or process that invoked process 1100. At 1130, a determination is made as to whether process 1100 is complete. In some embodiments, process 1100 is determined to be complete in response to a determination that no further DNS traffic is to be classified, an allocated time for performing the DNS traffic classification has elapsed (e.g., in the case of a real-time or inline detection) an administrator indicates that process 1000 is to be paused or stopped, etc. In response to a determination that process 1100 is complete, process 1100 ends. In response to a determination that process 1100 is not complete, process 1100 returns to 1105.

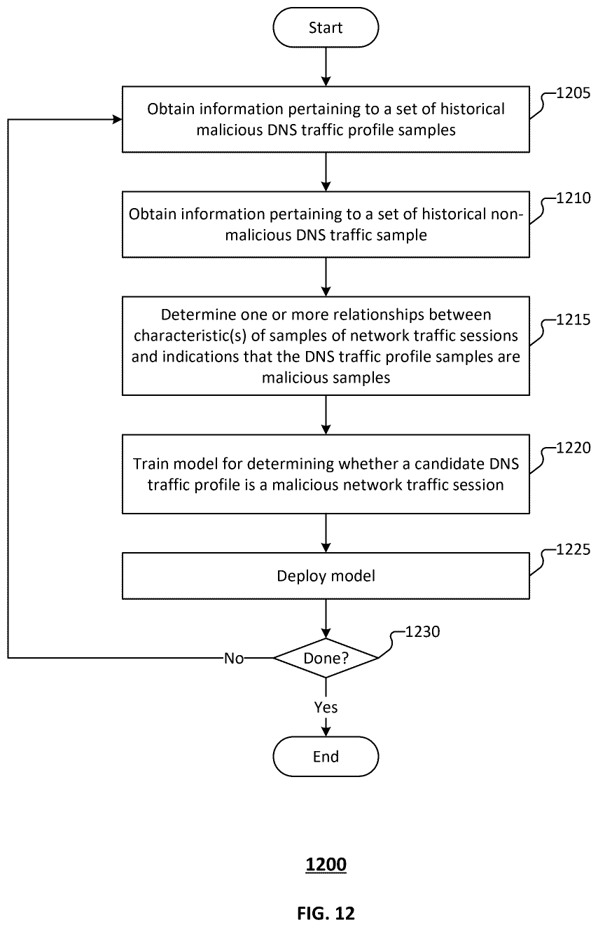

FIG. 12 is a flow diagram of a method for training a classifier for performing DNS traffic classifications according to various embodiments. According to various embodiments, process 1200 is implemented at least in part by one or more of system 100 of FIG. 1, system 200 of FIG. 2, and/or system 300 of FIG. 3.

At 1205, information pertaining to a set of historical malicious DNS traffic profile samples is obtained. For example, the set of historical malicious samples include samples of malicious DNS traffic profiles for DNS traffic that has been previously classified (or identified) as corresponding to malicious traffic. In some embodiments, the system obtains the information pertaining to a set of historical malicious DNS traffic profile samples from a third-party service (e.g., VirusTotal™). The system collects sample DNS traffic, including DNS traffic time series data. At 1210, information pertaining to a set of historical benign DNS traffic profile samples is obtained. For example, the set of historical benign DNS traffic profile samples include samples of non-malicious or benign DNS traffic sessions. In some embodiments, the system obtains the information pertaining to a set of historical benign DNS traffic profile samples from a third-party service (e.g., VirusTotal™). At 1215, the system determines one or more relationships between characteristic(s) of samples of network traffic sessions and indications that the samples are malicious samples. At 1220, a model is trained for determining whether a DNS traffic profile for DNS traffic time series data associated with DNS traffic is malicious. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, XGBoost, adaboost, etc. At 1225, the model is deployed. In some embodiments, the deploying of the model includes storing the model in a dataset of models for use in connection with analyzing traffic to determine whether the traffic is malicious. The deploying the model can include providing the model (or a location at which the model can be invoked) to a malicious traffic detector, such as DNS traffic classifier 170 of system 100 of FIG. 1, or to system 200 of FIG. 2 or system 300 of FIG. 3. At 1230, a determination is made as to whether process 1200 is complete. In some embodiments, process 1200 is determined to be complete in response to a determination that no further models are to be determined/trained (e.g., no further classification models are to be created), an administrator indicates that process 1200 is to be paused or stopped, etc. In response to a determination that process 1200 is complete, process 1200 ends. In response to a determination that process 1200 is not complete, process 1200 returns to 1205.

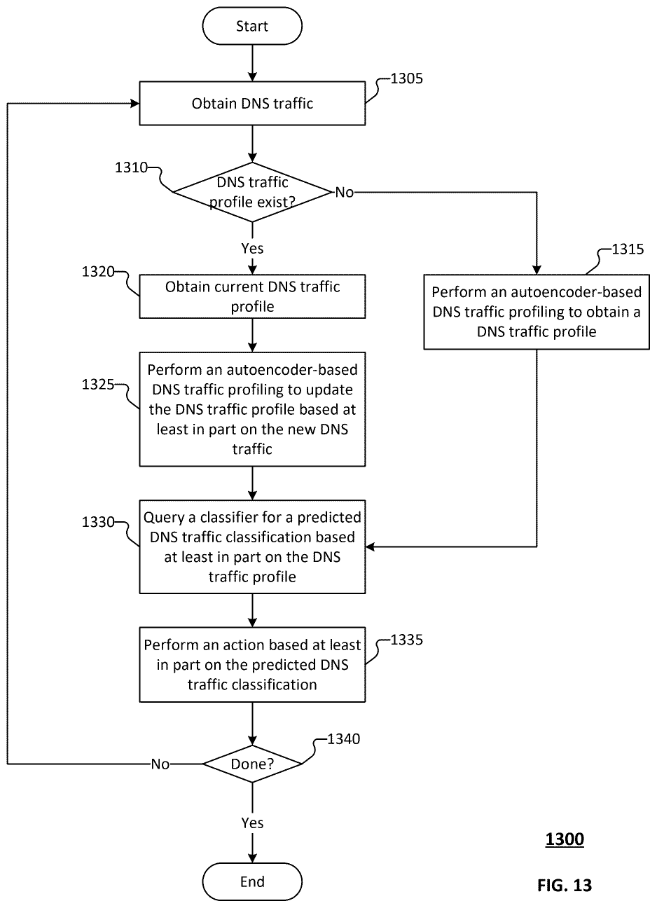

FIG. 13 is a flow diagram of a method for handling DNS traffic based on a predicted DNS traffic classification. According to various embodiments, process 1300 is implemented at least in part by one or more of system 100 of FIG. 1, system 200 of FIG. 2, and/or system 300 of FIG. 3.

In some embodiments, process 1300 is implemented by a cloud service (e.g., one or more servers) that provides DNS traffic classification services and/or other network security services to various network endpoints or security entities. For example, the system may implement process 1300 to perform offline detections based on historical DNS traffic samples obtained from traffic logs. As another example, the system may implement process 1300 contemporaneous with interception/handling of DNS traffic. An inline security entity provides to the system an intercepted DNS traffic sample for a real-time (e.g., near real-time) classification and the system implements 1300 contemporaneous with the security entity's handling of the DNS traffic.

At 1305, the system obtains DNS traffic. For example, the system obtains the DNS traffic based on intercepting DNS traffic (e.g., before returning a DNS response to the applicable client system). At 1310, the system determines whether a DNS traffic profile exists for the obtained DNS traffic. For example, the system determines whether a DNS traffic profile (e.g., a previously computed DNS traffic profile) is stored for the DNS traffic (e.g., the domain associated with the DNS traffic). In response to determining that the DNS profile does not exist for the DNS traffic profile, process 1300 proceeds to 1315. At 1315, the system performs an autoencoder-based DNS traffic profiling to obtain a DNS traffic profile. Conversely, in response to determining that a DNS traffic profile exists for the DNS traffic, process 1300 proceeds to 1320. At 1320, the system obtains a current DNS traffic profile. At 1325, the system performs an autoencoder-based DNS traffic profiling to update the DNS traffic profile based at least in part on the new DNS traffic. In some embodiments, the system invokes process 1400 to update the DNS traffic profile. At 1330, the system queries a classifier for a predicted DNS traffic classification based at least in part on the DNS traffic profile. At 1335, the system performs an action based at least in part on the predicted DNS traffic classification. For example, the system can enforce a security policy with respect to the DNS traffic based at least in part on the predicted DNS classification. At 1340, the system determines whether process 1300 is complete. In some embodiments, process 1300 is determined to be complete in response to a determination that no further DNS traffic is to be classified, no further DNS traffic is to be handled, an administrator indicates that process 1300 is to be paused or stopped, etc. In response to a determination that process 1300 is complete, process 1300 ends. In response to a determination that process 1300 is not complete, process 1300 returns to 1305.

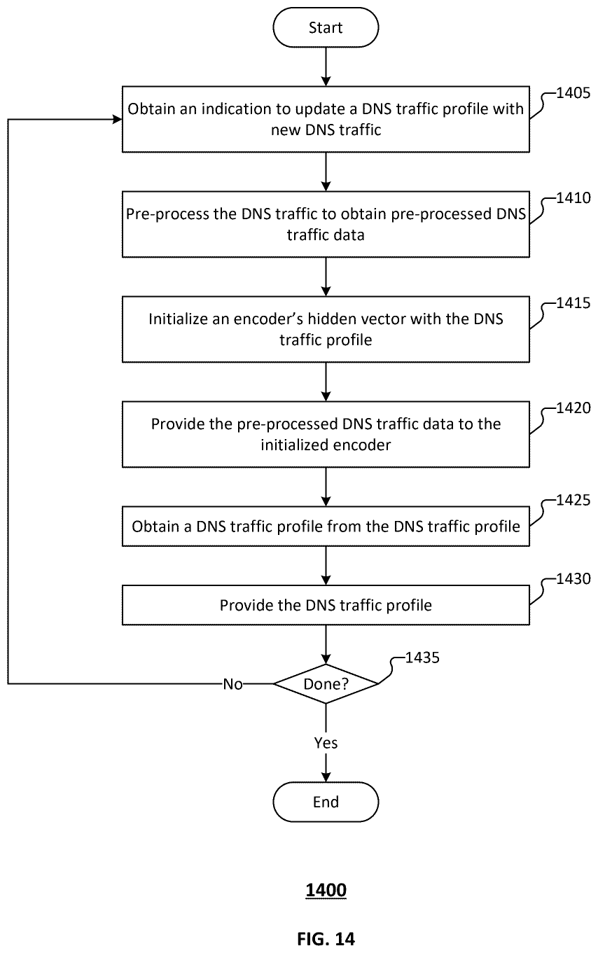

FIG. 14 is a flow diagram of a method for obtaining a DNS traffic profile based at least in part on intercepted DNS traffic according to various embodiments. According to various embodiments, process 1400 is implemented at least in part by one or more of system 100 of FIG. 1, system 200 of FIG. 2, and/or system 300 of FIG. 3.

In some embodiments, process 1400 is implemented by a cloud service (e.g., one or more servers) that provides DNS traffic classification services and/or other network security services to various network endpoints or security entities. For example, the system may implement process 1400 to perform offline detections based on historical DNS traffic samples obtained from traffic logs. As another example, the system may implement process 1400 contemporaneous with interception/handling of DNS traffic. An inline security entity provides to the system an intercepted DNS traffic sample for a real-time (e.g., near real-time) classification and the system implements 1400 contemporaneous with the security entity's handling of the DNS traffic.

In some embodiments, process 1400 is invoked by process 1300, such as at 1325.

At 1405, the system obtains an indication to update a DNS traffic profile with new DNS traffic. For example, the system obtains the indication to update the DNS traffic profile based at least in part on a determination that the system determines that it does not store a DNS profile for the DNS traffic. At 1410, the system pre-processes the DNS traffic to obtain pre-processed DNS traffic data. At 1415, the system initializes an encoder's hidden vector with the DNS profile. At 1420, the system provides the pre-processed DNS traffic data to the initialized encoder. At 1425, the system obtains a DNS traffic profile from the DNS traffic profile. At 1430, the system provides the DNS traffic profile. In some embodiments, the system provides the DNS traffic profile to the other system, service, or process that invoked process 1400, for example, to 1325. At 1435, the system determines whether process 1400 is complete. In some embodiments, process 1400 is determined to be complete in response to a determination that no further DNS traffic is to be classified, no further DNS traffic profiles are to be updated, no further DNS traffic is to be handled, an administrator indicates that process 1400 is to be paused or stopped, etc. In response to a determination that process 1400 is complete, process 1400 ends. In response to a determination that process 1400 is not complete, process 1400 returns to 1405.

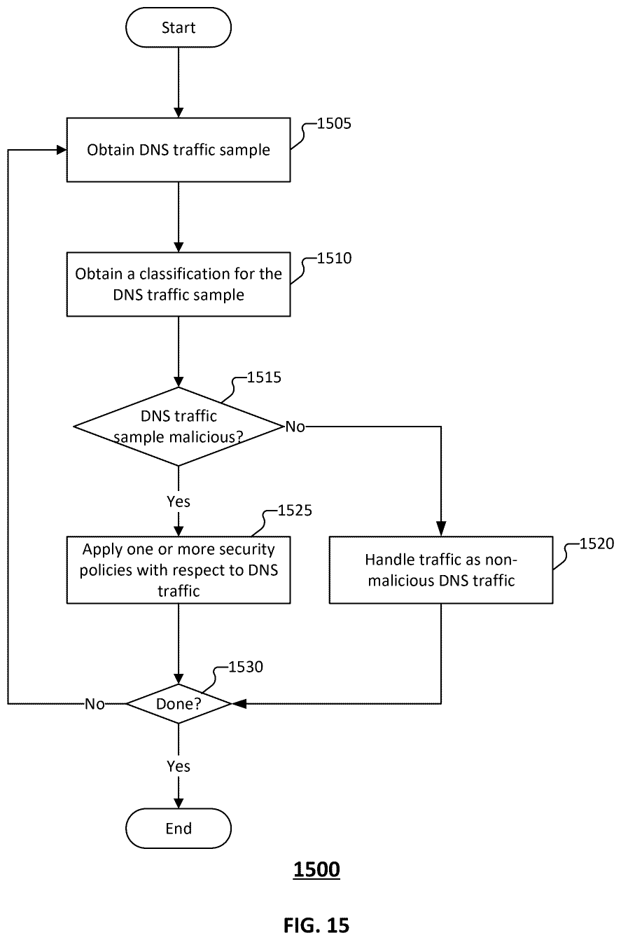

FIG. 15 is a flow diagram of a method for handling DNS traffic based on DNS traffic classifications according to various embodiments. According to various embodiments, process 1500 is implemented at least in part by one or more of system 100 of FIG. 1, system 200 of FIG. 2, and/or system 300 of FIG. 3.

In some implementations, process 1500 may be implemented by one or more servers, such as in connection with providing a service to a network (e.g., a security entity and/or a network endpoint such as a client device). In some implementations, process 1500 may be implemented by a security entity (e.g., a firewall) such as in connection with enforcing a security policy with respect to files communicated across a network or in/out of the network. In some implementations, process 1500 may be implemented by a client device such as a laptop, a smartphone, a personal computer, etc., such as in connection with communicating DNS traffic across a network.

In some embodiments, the system comprises a cloud service that provides near real-time traffic detection (e.g., a detection latency from the cloud service may be on the order of 10-50 ms).

At 1505, the system obtains a DNS traffic sample(s). The system may obtain network traffic sample(s) such as in connection with routing traffic within/across a network, or mediating traffic into/out of a network such as a firewall, or a monitoring of email traffic or instant message traffic.

At 1510, the system obtains a classification for the DNS traffic sample. For example, the system determines whether the DNS traffic sample is malicious. In some embodiments, the system queries a classifier for a contemporaneous DNS traffic classification (e.g., a real-time detection). For example, the system determines a DNS traffic profile and queries a classifier for a predicted classification based on the DNS traffic profile. In some embodiments, the system queries a whitelist (e.g., an allowlist) or a blacklist (e.g., a denylist) to determine whether the DNS traffic sample corresponds to an entry. For example, the system can query the whitelist or blacklist based on the domain associated with the DNS traffic sample or a DNS record comprised in the DNS traffic sample. The system may determine a signature for the DNS traffic sample (e.g., the domain and/or the DNS record) and query the whitelist and/or blacklist based on the signature.

In some embodiments, process 1500 invokes process 700 of FIG. 7 in connection with obtaining the classification.

According to various embodiments the system obtains a classification for the DNS traffic sample based at least in part on performing a look up against a blacklist (e.g., a deny list or a mapping of malicious samples to signatures) and/or whitelist (e.g., an allow list or a mapping of non-malicious or benign samples to signatures). The system can determine whether the DNS traffic sample (e.g., the correlated network traffic) has been previously analyzed/classified. For example, in response to performing a classification, the system computes a signature (e.g., perform a hash based on a predefined hashing function) and stores the signature in association with the classification.

In some embodiments, the system determines whether the DNS traffic sample corresponds to a sample comprised in a set of previously identified benign samples such as a whitelist of benign samples. In response to determining that the DNS traffic sample is comprised in the set of samples on the whitelist of benign samples, the system determines that the DNS traffic sample is not malicious.

According to various embodiments, in response to determining the DNS traffic sample is not comprised in a set of previously identified malicious samples (e.g., a blacklist of malicious samples) or a set of previously identified benign samples (e.g., a whitelist of benign files), the system deems the traffic DNS traffic as being non-malicious (e.g., benign) for the first-layer classification or the second-layer classification, as applicable.

According to various embodiments, in response to determining the DNS traffic sample is not comprised in a set of previously identified malicious samples (e.g., a blacklist of malicious samples) or a set of previously identified benign samples (e.g., a whitelist of benign samples), the system queries a malicious DNS traffic detector to determine whether the DNS traffic is malicious (e.g., to perform automatic DNS traffic detection). For example, the system may quarantine the DNS traffic until the system receives response form the malicious DNS traffic detector as to whether the DNS traffic sample is malicious. The malicious traffic detector may perform an assessment of whether the DNS traffic sample is malicious contemporaneous with the handling of the DNS traffic by the system (e.g., in real-time with the query from the system). The malicious traffic detector may correspond to DNS traffic classifier service 170 of system 100 of FIG. 1, system 200 of FIG. 2, and/or system 300 of Figure.

In some embodiments, in response to determining that the DNS traffic sample has not been previously classified, process 1500 can invoke process 700 or 800.

At 1515, the system determines whether the network traffic sample is malicious. For example, the system determines whether the classification indicates that the sample is malicious. As another example, the system determines whether the classification (e.g., the verdict from the second-layer classifier) comprises a probability or likelihood that the sample is malicious that exceeds a predefined maliciousness threshold.

In response to a determination that the traffic is not malicious traffic at 1515, process 1500 proceeds to 1520 at which the traffic is handled as non-malicious traffic/information.

In response to a determination that the traffic sample is malicious at 1515, process 1500 proceeds to 1525 at which the traffic is handled as malicious traffic/information. The system may handle the malicious traffic/information based at least in part on one or more policies such as one or more security policies.

According to various embodiments, the handling of malicious traffic/information may include performing an active measure. The active measure may be performed in accordance with (e.g., based at least in part on) one or more security policies. As an example, the one or more security policies may be preset by a network administrator, a customer (e.g., an organization/company) to a service that provides detection of malicious traffic, etc. Examples of active measures that may be performed include isolating the traffic (e.g., quarantining the traffic), deleting the traffic, blocking the traffic (e.g., blocking the return of a corresponding DNS record), prompting the user to alert the user that a malicious traffic was detected, blocking transmission of the traffic, updating a blacklist of malicious samples (e.g., a mapping of a hash for the traffic sample to an indication that the traffic sample is malicious, etc.).

At 1530, a determination is made as to whether process 1500 is complete. In some embodiments, process 1500 is determined to be complete in response to a determination that no further samples are to be analyzed (e.g., no further predictions for traffic are needed), no further correlated traffic is to be classified, no further network traffic is received, an administrator indicates that process 1500 is to be paused or stopped, etc. In response to a determination that process 1500 is complete, process 1500 ends. In response to a determination that process 1500 is not complete, process 1500 returns to 1505.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
perform an autoencoder-based DNS traffic profiling to obtain a DNS traffic profile, wherein the autoencoder-based DNS traffic profiling is based at least in part on time series DNS traffic data;
obtain a classification for DNS traffic associated with the time series DNS traffic data based at least in part on the DNS traffic profile; and
perform an action based at least in part on the classification; and
a memory coupled to the one or more processors and configured to provide the one or more processors with instructions.

2. The system of claim 1, wherein performing the autoencoder-based DNS traffic profiling comprises:
converting the time series DNS traffic data into a fixed dimensional vector.

3. The system of claim 2, wherein the classification is obtained based at least in part on a distance comparison using the fixed dimensional vector.

4. The system of claim 1, wherein:
performing the autoencoder-based DNS traffic profiling comprises:
obtaining the time series DNS traffic data;
pre-processing the time series DNS traffic data to obtain pre-processed time series DNS traffic data; and
the autoencoder-based DNS traffic profiling is performed with respect to the pre-processed time series DNS traffic data.

5. The system of claim 4, wherein the pre-processing the time series DNS traffic data to obtain pre-processed time series DNS traffic data comprises:
obtain a set of timestamps for a corresponding set of time series DNS traffic samples comprised in the series DNS traffic data; and
compute a set of time intervals between timestamps for sequential time series DNS traffic samples comprised in the set of time series DNS traffic samples.

6. The system of claim 4, wherein the pre-processing the time series DNS traffic data to obtain pre-processed time series DNS traffic data further comprises:
compute a set of time interval logarithms based on the set of time intervals, wherein a time interval logarithm comprised in the set of time interval logarithms is used in connection with encoding time data in connection with the DNS traffic data to obtain the DNS traffic profile.

7. The system of claim 1, wherein obtaining classification for DNS traffic associated with the time series DNS traffic data based at least in part on the DNS traffic profile comprises querying a classifier for a predicted classification.

8. The system of claim 7, wherein the classifier is a machine learning model.

9. The system of claim 8, wherein the machine learning model is a random forest model.

10. The system of claim 8, wherein the machine learning model is a decision tree model.

11. The system of claim 1, wherein the classifier is trained to detect a malicious DNS traffic profile.

12. The system of claim 1, wherein obtaining the classification for DNS traffic comprises detecting malicious DNS traffic based at least in part on the classification.

13. The system of claim 1, wherein performing the action comprises:
in response to determining that the DNS traffic is malicious DNS traffic, blocking traffic to a domain corresponding to the DNS traffic.

14. The system of claim 1, wherein performing the action comprises:
in response to determining that the DNS traffic is benign DNS traffic, updating a whitelist to comprise a domain corresponding to the DNS traffic.

15. The system of claim 1, wherein the one or more processors are further configured to:
monitor DNS traffic at a security platform; and
obtain time series DNS traffic data based at least in part on the monitored DNS traffic.

16. The system of claim 15, wherein the DNS traffic monitored at the security platform is intercepted by an inline security entity.

17. The system of claim 1, wherein the classification for the DNS traffic is performed in real-time.

18. The system of claim 1, wherein the classification for the DNS traffic comprises one or more of C2 domain traffic detection, spam email traffic detection, squatting domain traffic detection, and gambling domain traffic detection.

19. A method, comprising:
performing an autoencoder-based DNS traffic profiling to obtain a DNS traffic profile, wherein the autoencoder-based DNS traffic profiling is based at least in part on time series DNS traffic data;
obtaining a classification for DNS traffic associated with the time series DNS traffic data based at least in part on the DNS traffic profile; and
performing an action based at least in part on the classification.

20. A computer program product embodied in a non-transitory computer readable medium and comprising computer instructions for:
performing an autoencoder-based DNS traffic profiling to obtain a DNS traffic profile, wherein the autoencoder-based DNS traffic profiling is based at least in part on time series DNS traffic data;
obtaining a classification for DNS traffic associated with the time series DNS traffic data based at least in part on the DNS traffic profile; and
performing an action based at least in part on the classification.
